(19) United States
(12) Patent Application Publication
(10) Pub. No.: US 2026/0190057 A1
(43) Pub. Date: Jul. 2, 2026

(54) SYSTEMS AND METHODS FOR UPLINK MULTI-TRP OPERATION ENHANCEMENT

(71) Applicant: APPLE INC., Cupertino, CA (US)

(72) Inventors: Haitong Sun, Cupertino, CA (US); Weidong Yang, San Diego, CA (US); Dan Wu, Beijing (CN); Dawei Zhang, Saratoga, CA (US); Wei Zeng, Saratoga, CA (US); Hong He, San Jose, CA (US); Ankit Bhamri, Bad Nauheim (DE); Seyed Ali Akbar Fakoorian, San Diego, CA (US)

(21) Appl. No.: 18/848,201

(22) PCT Filed: Sep. 27, 2023
(86) PCT No.: PCT/CN2023/122093

§ 371 Date: Sep. 18, 2024

(51) Int. Cl. H04W 56/00

(52) U.S. Cl. CPC H04W 56/0045

(57) ABSTRACT

Systems and methods for uplink (UL) multiple transmission reception point (multi-TRP) operation enhancements are disclosed herein. Embodiments may provide enhancements for the handling of a time alignment timer (TAT) expiration for two timing advance groups (TAGs). A UE may perform one or more actions associated with a multiple downlink control information (multi-DCI) multi-TRP operation based on whether a first TAG and a second TAG are, respectively, associated with a primary timing advance group (PTAG) or a secondary timing advance group (STAG).

### TECHNICAL FIELD

This application relates generally to wireless communication systems, including systems with uplink (UL) multiple transmission reception point (multi-TRP) operation.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A, FIG. 1B, FIG. 1C, and FIG. 1D illustrate UL time and frequency resources for different STxMP modes for DCI simultaneously transmitted in a first beam and a second beam using multiple antenna panels that may be used according to certain embodiments.

FIG. 2A and FIG. 2B illustrates an example of a multi-DCI multi-TRP operation with varying propagation delays for UL receptions at different TRPs that may be used according to certain embodiments.

FIG. 3 illustrates a flowchart of a method for a UE, according to embodiments herein.

FIG. 4 illustrates a flowchart of a method for a base station, according to embodiments herein.

FIG. 5 illustrates a flowchart of a method for a base station, according to embodiments herein.

FIG. 6 illustrates a flowchart of a method for a UE, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some wireless communication systems with multiple input multiple output (MIMO) support enhancements for uplink (UL) multiple transmission and reception point (multi-TRP) operation. For example, two timing advance (TA) values may be supported for the same serving cell and/or simultaneous UL transmission with multiple panels (STxMP) may be used.

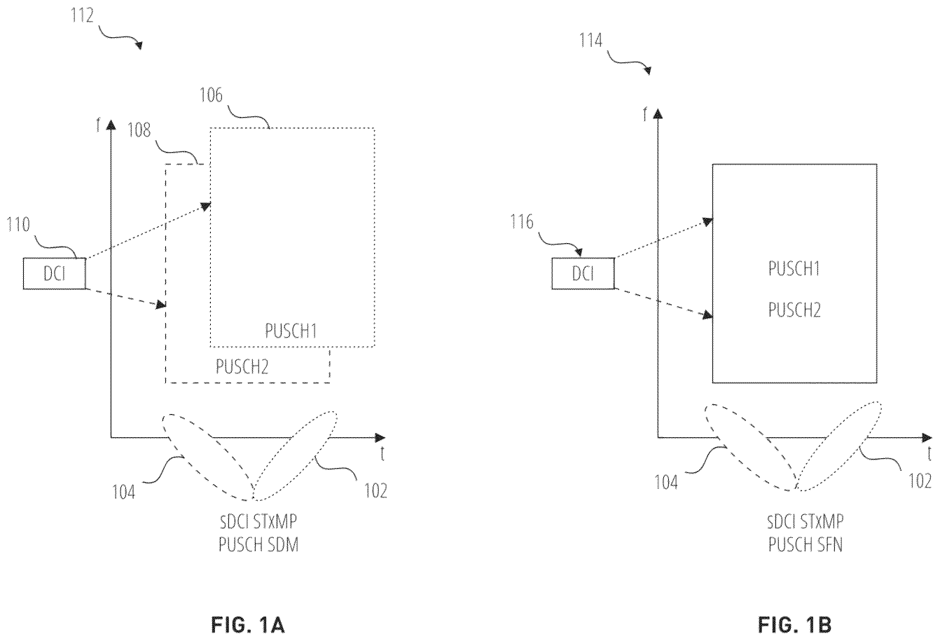

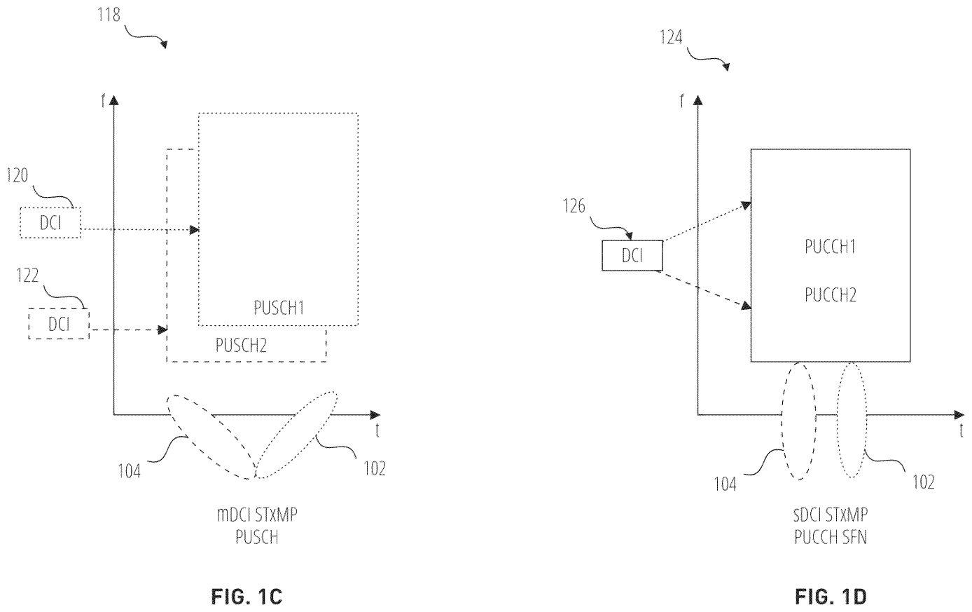

Further, in certain wireless communication systems, for STxMP, four different cases are supported. For example, FIG. 1A to FIG. 1D illustrate UL time (t) and frequency (f) resources for different STxMP modes for DCI simultaneously transmitted in a first beam 102 and a second beam 104 using multiple antenna panels.

FIG. 1A illustrates one such case wherein a single-downlink control information (sDCI) STxMP PUSCH spatial domain multiplexing (SDM) sDCI STxMP PUSCH SDM operation 112 is supported. As illustrated in FIG. 1A, for the sDCI STxMP PUSCH SDM operation 112, a single DCI 110 may be transmitted in both a first PUSCH 106 (PUSCH1) and a second PUSCH 108 (PUSCH2), according to spatial domain multiplexing.

FIG. 1B illustrates a second case wherein an sDCI STxMP PUSCH single frequency network (SFN) operation is supported. As illustrated in FIG. 1B, for the sDCI STxMP PUSCH SFN operations 114, a single DCI 116 may be transmitted in both the PUSCH1 and the PUSCH2 through each panel in the form of SFN.

FIG. 1C illustrates a third case wherein a multiple downlink control information (mDCI) STxMP PUSCH operation is supported. As illustrated in FIG. 1C, for the mDCI STxMP PUSCH operation 118 operation, a UE may transmit a first DCI 120 in PUSCH1 using a first panel and a second DCI 122 in PUSCH2 using a second panel.

FIG. 1D illustrates a fourth such case wherein an sDCI STxMP physical uplink control channel (PUCCH) SFN operation is supported. As illustrated in FIG. 1D, for the sDCI STxMP PUCCH SFN operation 124 operation, one DCI 126 may be transmitted in a first PUCCH (PUCCH1) and a second PUCCH (PUCCH2) through each panel in the form of SFN.

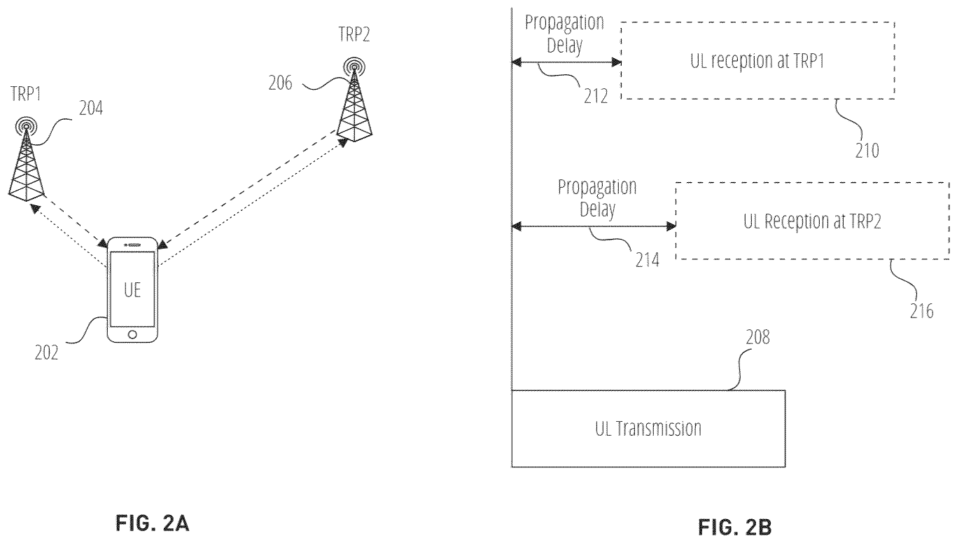

FIG. 2A and FIG. 2B illustrates an example of a multi-DCI multi-TRP operation with varying propagation delays for UL receptions at different TRPs. In this example, a UE 202 simultaneously communicates with a first TRP 204 (TRP1) and a second TRP 206 (TRP2). For two TA operation, two TAs are supported for UL multi-DCI multi-TRP operation for the same serving cell (i.e., per serving cell). Further, two TAs are supported by configuring two timing advance groups (TAGs) for the same serving cell.

As illustrated in FIG. 2B, for UL transmissions 208 made during multi-DCI, multi-TRP operations, UL reception 210 at TRP1 may have a first propagation delay 212 that is smaller than a second propagation delay 214 of UL reception 216 at TRP2. Thus, the transmissions are out of sync and may be unreliable.

Embodiments disclosed herein provide UL multi-TRP operation enhancements. For example, some embodiments disclosed herein provide enhancements for the handling of a time alignment timer (TAT) expiration for two TAs that are supported by configuring two TAGs for the same serving cell. In some cases, this may assist in avoiding unnecessary system interference or delay associated with resynchronization when UE uplink timers (e.g., TATs) are out of sync and the ongoing transmission is no longer reliable. In addition, or in other embodiments, enhancements are provided for configuring different STxMP modes.

### Handling of Time Alignment Timer Expiration

In current wireless communication systems, for medium access control (MAC) (see, e.g., 3GPP Technical Specification (TS) 38.321) a UE maintains a separate TAT for each TAG for the maintenance of UL time alignment. For example, a radio resource control (RRC) configures a TAT parameter for the maintenance of UL time alignment. The TAT parameter (i.e., as configured per TAG) controls how long the MAC entity considers the serving cells belonging to the associated TAG to be uplink time aligned.

In some cases, when the TAT expires, the UE performs corresponding actions, which may be different depending on whether the corresponding TAG is a primary timing advance group (PTAG) or secondary timing advance group (STAG). A PTAG is a TAG containing a special cell (SpCell) of a MAC entity and an STAG refers to other TAGs. An SpCell may be a primary cell (PCell) in a master cell group (MCG) or a primary secondary cell (PSCell) in a secondary cell group (SCG).

In certain systems, when a TAT (e.g., timeAlignmentTimer) expires, if the TAT is associated with the PTAG, the UE may, for example: flush all hybrid automatic repeat request (HARQ) buffers for all serving cells; notify RRC to release PUCCH for all serving cells, if configured; notify an RRC to release a sounding reference signal (SRS) for all serving cells, if configured; clear any configured downlink assignments and configured uplink grants; clear any PUSCH resources for semi-persistent channel state information (CSI) reporting; consider all running TATs as expired; and/or maintain a value of time advances (NTA) (e.g., as provided in 3GPP TS 38.211) of all TAGs.

On the other hand, when a TAT (e.g., timeAlignmentTimer) expires, if the TAT is associated with an STAG, then for all serving cells belonging to the TAG, the UE may, for example: flush all HARQ buffers; notify the RRC to release a PUCCH, if configured; notify the RRC to release a SRS, if configured; clear any configured downlink assignments and configured uplink grants; clear any PUSCH resource for semi-persistent CSI reporting; and/or maintain NTA (e.g., as provided in 3GPP TS 38.211) of the TAG.

In a first embodiment, when an SpCell is configured with multi-DCI multi-TRP operation, and two TAs (i.e., TAGs) are configured for the SpCell, for PTAG and/or STAG determination, the UE may determine which TAG is PTAG based on either a predetermined designation (e.g., in a 3GPP specification) or as configured by the network. When the PTAG is predetermined in the specification, both TAGs may be considered as PTAG or only one TAG may be considered as a PTAG (e.g., the first TAG or the TAG with the smaller TAG identifier (ID) (i.e., a TAG-Id) is considered the PTAG). When PTAG is configured by the network, the network can configure both TAGs as PTAGs or the network can configure one TAG as PTAG. Additionally, or alternatively, if both TAGs are considered as PTAGs, one TAG considered as the PTAG may be predetermined in the specification and one TAG considered as the PTAG may be configured by the network.

In a second embodiment, when an SCell is configured with multi-DCI multi-TRP operation, and two TAGs are configured for the SCell, both TAGs are considered as STAGs.

In a third embodiment, an SpCell is configured with multi-DCI multi-TRP operation, two TAs (i.e., TAGs) are configured for the SpCell, and each TAG (e.g., TAG1 and TAG2) has its own TAT. If only one TAG is considered a PTAG, (e.g., TAG1), and further if the TAT of TAG1 expires, a running TAT of TAG2 is also considered as expired. In other cases, a running TAT of TAG2 is not considered as expired. In certain embodiments, if the TAT of TAG1 expires, in either of the described cases, the other running TATs (e.g., the TATs of the secondary cells), excluding the TAT of TAG2, are considered expired.

Alternatively, if both TAGs, (i.e., TAG1 and TAG2) are considered as a PTAG, in some cases, all the other running TATs, excluding the TAT of TAG1 and the TAT of TAG2, may be considered as expired when both the TAT of TAG1 and the TAT of TAG2 expire. In other cases, all the other running TATs, excluding the TAT of TAG1 and the TAT of TAG2, may be considered as expired when at least one of a TAT of TAG1 and a TAT of TAG2 expires. Regarding the expiration of the TAT of TAG1 and the TAT of TAG2, in some cases the expiration of TAG1 and TAG2 are independent (i.e., it is allowed that one TAT expires, but the other one does not). In other cases, the expiration of a TAT of TAG1 causes the TAT of TAG2 to expire, and the expiration of a TAT of TAG2 causes the TAT of TAG1 to expire.

In a fourth embodiment, a SpCell is configured with multi-DCI multi-TRP operation, two TAs (i.e., TAGs) are configured for the SpCell, and each TAG (e.g., TAG1 and TAG2) has its own TAT. If one TAG is considered as a PTAG, (e.g., TAG1), and further if the TAT of TAG1 expires, there may be an impact on the downlink (DL) and UL operation for all serving cells as the transmission is considered to be out of sync.

However, if both TAGs (e.g., TAG1 and TAG2) are considered as PTAG, there may be an impact on DL and UL operation for all serving cells, when in some cases both the TAT of TAG1 and the TAT of TAG2 expire, and in other cases when at least one of the TAT of TAG1 and the TAT of TAG2 expires. When the TAT of a TAG (e.g., TAG1) expires but the other TAT of the other TAG (e.g., TAG2) does not expire, in some cases all the DL and UL operations associated with TAG1 may be impacted as the TAG1 transmission is out of sync, but the DL and UL operations associated with TAG2 are not impacted as the TAG2 transmission is still in sync. In other cases, all the DL and UL operations associated with either TAG1 or TAG2 may be impacted, as both the transmission associated with TAG1 and transmission associated with TAG2 are out of sync.

In a fifth embodiment, for a cell that is configured with two TAs (i.e., TAGs), and each TAG (e.g., TAG1 and TAG2) has its own TAT, if one TAT of one TAG, (e.g., TAG1) expires but the other TAT of the other TAG (e.g., TAG2) does not expire, in some cases all HARQ buffers remain valid, and in other cases all HARQ buffers are flushed.

In other cases, only the HARQ buffers in the corresponding cell that are associated with the expired TATs are flushed. When associating a HARQ process and/or a HARQ buffer with a TAG, in some cases a HARQ process is associated with the same TAG that is associated with the PUCCH resource (PUCCH-Resource) information element (IE) configured and/or indicated to carry the latest HARQ-acknowledgement (HARQ-ACK) feedback, and in other cases the network configures the associated TAG for each HARQ process explicitly by RRC signaling.

In a sixth embodiment, for a cell that is configured with two TAs (i.e., TAGs), and each TAG (e.g., TAG1 and TAG2) has its own TAT, if one TAT of one TAG (e.g., TAG1) expires but the other TAT of the other TAG (e.g., TAG2) does not expire, in some cases only the UL channels and/or signals in the corresponding cell that are associated with the expired TAT are released and/or cleared, and in other cases all UL channels and/or signals in the corresponding cell are released and/or cleared. The UL channels and/or signals may include, for example, PUCCH-Resource IEs, SRS resources/resource sets, configured uplink grants, and/or PUSCH resource for semi-persistent CSI reporting.

In a seventh embodiment, for a cell that is configured with two TAs (i.e., TAGs) (e.g., TAG1 and TAG2), and each TAG has its own TAT, if one TAT of one TAG (e.g., TAG1) expires but the other TAT of the other TAG (e.g., TAG2) does not expire, for a configured downlink assignment, in some cases all configured downlink assignments in the corresponding cell are released and/or cleared.

In other cases the configured downlink assignments in the corresponding cell that are associated with the expired TAT are released and/or cleared. To associate a configured downlink assignment with a TAG, in some cases a configured downlink assignment is associated with the same TAG that is associated with the PUCCH-Resource IE configured to carry the HARQ-ACK feedback for the corresponding configured downlink assignment, and in other cases the network configures the associated TAG for each configured downlink assignment explicitly by RRC signaling.

### Configuration of Different STxMP Modes

Certain embodiments provide enhancements for configuring different STxMP modes. The following embodiments may be combined with one another and/or with the embodiments discussed above.

In a first embodiment for a single-DCI (sDCI) STxMP PUSCH SDM operation, the network configures the operation explicitly via RRC signaling. In some cases, the network configures an sDCI STxMP PUSCH SDM operation explicitly in a PUSCH configuration (PUSCH-Config) IE. For example, the sDCI STxMP PUSCH SDM operation can be enabled and/or disabled differently per UL bandwidth part (BWP). In other cases, the network configures an sDCI STxMP PUSCH SDM operation explicitly in a dedicated UL BWP (BWP-UplinkDedicated) IE. For example, the sDCI STxMP PUSCH SDM operation can be enabled and/or disabled differently per UL BWP. In other cases, the network configures an sDCI STxMP PUSCH SDM operation explicitly in an UL configuration (UplinkConfig) IE and/or in a serving cell configuration (ServingCellConfig) IE. For example, the sDCI STxMP PUSCH SDM operation may be enabled and/or disabled across all UL BWPs in the same component carrier (CC).

In a second embodiment for a DCI STxMP PUSCH SFN operation, the network configures the operation explicitly via RRC signaling. In some cases, the network configures the sDCI STxMP PUSCH SFN operation explicitly in a PUSCH-Config IE. For example, the sDCI STxMP PUSCH SFN operation can be enabled and/or disabled differently per UL BWP. In other cases, the network configures the sDCI STxMP PUSCH SFN operation explicitly in a BWP-UplinkDedicated IE. For example, the sDCI STxMP PUSCH SFN can be enabled and/or disabled differently per UL BWP. In other cases, the network configures the sDCI STxMP PUSCH SFN operation explicitly in an UplinkConfig IE and/or in a ServingCellConfig IE. For example, the sDCI STxMP PUSCH SFN operation may be enabled and/or disabled across all UL BWPs in the same CC.

In a third embodiment, in the same UL BWP in a CC, a UE is not expected to be configured with an sDCI STxMP PUSCH SDM operation and an sDCI STxMP PUSCH SEN operation simultaneously.

In a fourth embodiment, for mDCI STxMP PUSCH operations, the network configures the operation explicitly via an RRC signaling. In some cases, the network configures the mDCI STxMP PUSCH operation explicitly in a PUSCH-Config IE. For example, the mDCI STxMP PUSCH operation can be enabled and/or disabled differently per UL BWP. In other cases, the network configures the mDCI STxMP PUSCH operation explicitly in a BWP-UplinkDedicated IE. For example, the mDCI STxMP PUSCH operation can be enabled and/or disabled differently per UL BWP. In other cases, the network configures the mDCI STxMP PUSCH operation explicitly in an UplinkConfig IE and/or in a ServingCellConfig IE. For example, the mDCI STxMP PUSCH may be enabled and/or disabled across all UL BWPs in the same CC.

In a fifth embodiment, for mDCI STxMP PUSCH operations, the network configures the operation implicitly via RRC signaling, in a DL BWP in a CC. The network may configure two different control resource set resource pool index (coresetPoolIndex) values (e.g., 0 and 1) for different ControlResourceSet parameters. In some cases, when the coresetPoolIndex value is not explicitly configured for a ControlResourceSet parameter, it is assumed to be 0. Further, in certain embodiments, a new coresetPoolIndex-r17 IE is introduced in addition to a coresetPoolIndex-r16 IE. However, in the same DL BWP, only one coresetPoolIndex IE is expected to be configured for all ControlResourceSets parameters.

In a sixth embodiment, a UE is not expected to be configured with any two of the following three operations simultaneously in the same UL BWP in a CC: an sDCI STxMP PUSCH SDM operation; an sDCI STxMP PUSCH SFN operation; and/or an mDCI STxMP PUSCH operation. For example, the UE may be enabled with one of the three operations or with two of the three operations.

In a seventh embodiment, for a single CC, the UE is not expected to be configured with both of the following operations simultaneously on the active UL BWP and the active DL BWP: an sDCI STxMP PUSCH SDM operation or an sDCI STxMP PUSCH SFN operation when the operation is configured per UL BWP or per UL CC; and an mDCI STxMP PUSCH operation when the mDCI STxMP PUSCH operation is configured per DL BWP via a coresetPoolIndex configuration IE. In some embodiments, the sDCI and mDCI operations are to be kept separate.

In an eighth embodiment, in a BWP and/or CC, when a UE is configured with one of an sDCI STxMP PUSCH SDM operation, an sDCI STxMP PUSCH SFN operation, or a mDCI STxMP PUSCH operation, the UE is configured with two sounding reference signal resource set (SRS-ResourceSet) IEs with the usage of a codebook or a non-codebook. Further, when the UE is also configured with a PUSCH repetition that is indicated by a PUSCH-AggregationFactor configured in a PUSCH-Config or a numberOfRepetitions configured in PUSCH-Allocation-r16, the expected UE behavior includes: the UE not performing a Rel-17 PUSCH repetition with different beam and/or power control in different PUSCH transmission and/or repetition occasions; and/or the UE only performing legacy Rel-17 PUSCH repetition (e.g., in different PUSCH transmission and/or repetition occasions, the same beam, precoder, and/or power control is applied).

In a ninth embodiment, for a PUCCH-Resource, if the network configures an sDCI STxMP PUCCH SFN operation, the network performs at least one of using a MAC control element (MAC-CE) to activate two spatial relations for the PUCCH-Resource IE, or using a MAC-CE to activate two power control parameters set for the PUCCH-Resource IE.

When the UE is configured with a PUCCH repetition (e.g., a number of slots (nrofSlots) in a PUCCH-Resource or a PUCCH repetition number of slots (pucch-RepetitionNrofSlots) in a PUCCH-Resource IE), the expected UE behavior includes the UE not performing a Rel-17 PUCCH repetition with different beam/power control in different PUCCH transmission occasions and/or repetition occasions, and/or the UE only performing legacy PUCCH repetition (e.g., in different PUCCH transmission occasions and/or repetition occasions, the same pair of beams, precoders, and/or power controls is applied).

In a tenth embodiment, an sDCI STxMP PUCCH SFN operation and an mDCI STxMP PUSCH operation cannot be configured simultaneously.

In an eleventh embodiment, an sDCI STxMP PUCCH SEN operation and an sDCI STxMP PUSCH SDM operation cannot be configured simultaneously.

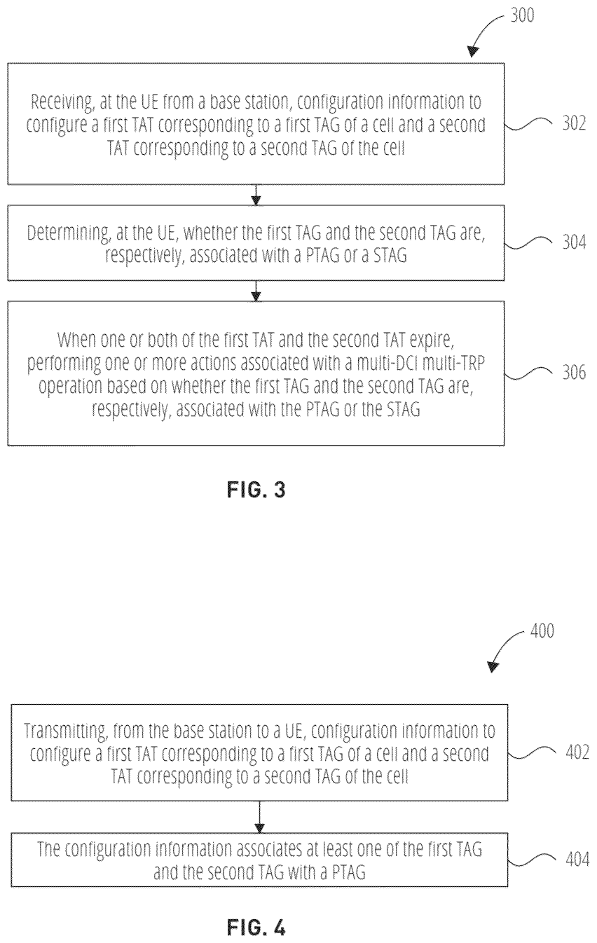

FIG. 3 illustrates a flowchart of a method 300 for a UE, according to embodiments herein. The illustrated method 300 includes receiving 302, at the UE from a base station, configuration information to configure a first TAT corresponding to a first TAG of a cell and a second TAT corresponding to a second TAG of the cell. The method 300 further includes determining 304, at the UE, whether the first TAG and the second TAG are, respectively, associated with a PTAG or a STAG. The method 300 further includes, when one or both of the first TAT and the second TAT expire, performing 306 one or more actions associated with a multi-DCI multi-TRP operation based on whether the first TAG and the second TAG are, respectively, associated with the PTAG or the STAG.

In certain embodiments of the method 300, the cell comprises an SpCell including a PCell in a master cell group or a PSCell in a secondary cell group, wherein the SpCell is configured for the multi-DCI multi-TRP operation.

In other embodiments, determining whether the first TAG and the second TAG are, respectively, associated with the PTAG or the STAG comprises determining that both the first TAG and the second TAG are predetermined as being associated with the PTAG.

In other embodiments, determining whether the first TAG and the second TAG are, respectively, associated with the PTAG or the STAG comprises determining that the first TAG is predetermined as being associated with the PTAG and the second TAG is predetermined as being associated with the STAG. In certain such embodiments, a first TAG ID of the first TAG is smaller than a second TAG ID of the second TAG.

In other embodiments, determining whether the first TAG and the second TAG are, respectively, associated with the PTAG or the STAG comprises determining that the configuration information indicates a network configuration of both the first TAG and the second TAG as being associated with the PTAG.

In other embodiments, determining whether the first TAG and the second TAG are, respectively, associated with the PTAG or the STAG comprises determining that the configuration information indicates a network configuration of the first TAG as being associated with the PTAG and the second TAG as being associated with the STAG.

In certain embodiments of the method 300, the one or more actions include, when the first TAG is associated with the PTAG and the second TAG is associated with the STAG, and when the first TAT expires: considering the second TAT as expired, and considering any running TAT of an SCell as expired.

In certain embodiments of the method 300, the one or more actions include, when first TAG is associated with the PTAG and the second TAG is associated with the STAG, and when the first TAT expires: considering that the second TAT, when running, is not expired, and considering any running TAT of an SCell, other than the second TAT, as expired.

In certain embodiments of the method 300, the one or more actions include, when both the first TAG and the second TAG are associated with the PTAG, considering any running TAT, other than the first TAT and the second TAT, as expired when both the first TAT and the second TAT expire.

In certain embodiments of the method 300, the one or more actions include, when both the first TAG and the second TAG are associated with the PTAG, considering any running TAT, other than the first TAT and the second TAT, as expired when either the first TAT expires or the second TAT expires.

In certain embodiments of the method 300, the one or more actions include, when both the first TAG and the second TAG are associated with the PTAG, allowing the first TAT and the second TAT expire independently of one another.

In certain embodiments of the method 300, the one or more actions include, when both the first TAG and the second TAG are associated with the PTAG, when the first TAT expires considering the second TAT to be expired, and when the second TAT expires considering the first TAT to be expired.

In certain embodiments of the method 300, the one or more actions include, when the first TAG is associated with the PTAG and the second TAG is associated with the STAG, and when the first TAT expires, stopping DL operation and UL operation by the UE on both the first TAG and the second TAG.

In certain embodiments of the method 300, the one or more actions include, when both the first TAG and the second TAG are associated with the PTAG, and when both the first TAT expires and the second TAT expires, stopping DL operation and UL operation by the UE on both the first TAG and the second TAG.

In certain embodiments of the method 300, the one or more actions include, when both the first TAG and the second TAG are associated with the PTAG, and when at least one of the first TAT expires and the second TAT expires, stopping DL operation and UL operation by the UE on both the first TAG and the second TAG.

In certain embodiments of the method 300, the one or more actions include, when both the first TAG and the second TAG are associated with the PTAG, and when the first TAT expires and the second TAT is running, stopping DL operation and UL operation by the UE on the first TAG without impacting the DL operation and the UL operation on the second TAG.

In certain embodiments of the method 300, the cell comprises an SCell configured for the multi-DCI multi-TRP operation, and wherein determining whether the first TAG and the second TAG are, respectively, associated with the PTAG or the STAG comprises considering both the first TAG and the second TAG as being associated with the STAG.

In certain embodiments of the method 300, the one or more actions include, when the first TAT expires while the second TAT is running, considering HARQ buffers associated with both the first TAG and the second TAG to remain valid.

In certain embodiments of the method 300, the one or more actions include, when the first TAT expires while the second TAT is running, flushing HARQ buffers associated with both the first TAG and the second TAG.

In certain embodiments of the method 300, the one or more actions include, when the first TAT expires while the second TAT is running, considering HARQ buffers associated with the second TAG to remain valid and flushing the HARQ buffers associated with and the first TAG. Some such embodiments further comprise, associating a HARQ process with the first TAG or the second TAG based on a PUCCH resource configured or indicated by the base station to carry a latest HARQ-ACK feedback. Other embodiments further comprise, associating a HARQ process with the first TAG or the second TAG based on an RRC configuration by the network.

In certain embodiments of the method 300, the one or more actions include, when the first TAT expires while the second TAT is running, releasing or clearing UL channels or UL signals in serving cells associated only with the first TAG.

In certain embodiments of the method 300, the one or more actions include, when the first TAT expires while the second TAT is running, releasing or clearing UL channels or UL signals in serving cells associated with both the first TAG and the second TAG.

In certain embodiments of the method 300, the one or more actions include, when the first TAT expires while the second TAT is running, releasing or clearing configured DL assignments in serving cells associated with both the first TAG and the second TAG.

In certain embodiments of the method 300, the one or more actions include, when the first TAT expires while the second TAT is running, releasing or clearing configured DL assignments in serving cells associated only with the first TAG. Some such embodiments further comprise, associating the configured DL assignments with the first TAG based on a PUCCH resource configured by the base station to carry a HARQ-ACK feedback for the configured DL assignments. Other embodiments further comprise, associating the configured DL assignments with the first TAG based on an RRC configuration by the network.

FIG. 4 illustrates a flowchart of a method 400 for a base station, according to embodiments herein. The illustrated method 400 includes transmitting 402, from the base station to a UE, configuration information to configure a first TAT corresponding to a first TAG of a cell and a second TAT corresponding to a second TAG of the cell. The configuration information associates 404 at least one of the first TAG and the second TAG with a PTAG.

In certain embodiments of the method 400, the cell comprises an SpCell including a PCell in a master cell group or a PSCell in a secondary cell group, wherein the SpCell is configured for the multi-DCI multi-TRP operation, and wherein the configuration information associates both the first TAG and the second TAG with the PTAG.

In certain embodiments of the method 400, the cell comprises an SpCell including a PCell in a master cell group or a PSCell in a secondary cell group, wherein the SpCell is configured for the multi-DCI multi-TRP operation, and wherein the configuration information associates the first TAG with the PTAG and the second TAG with an STAG.

In certain embodiments, the method 400 further comprises transmitting, from the base station to the UE, RRC signaling to associate HARQ processes to either the first TAG or the second TAG.

In certain embodiments, the method 400 further comprises transmitting, from the base station to the UE, RRC signaling to associate configured DL assignments to either the first TAG or the second TAG.

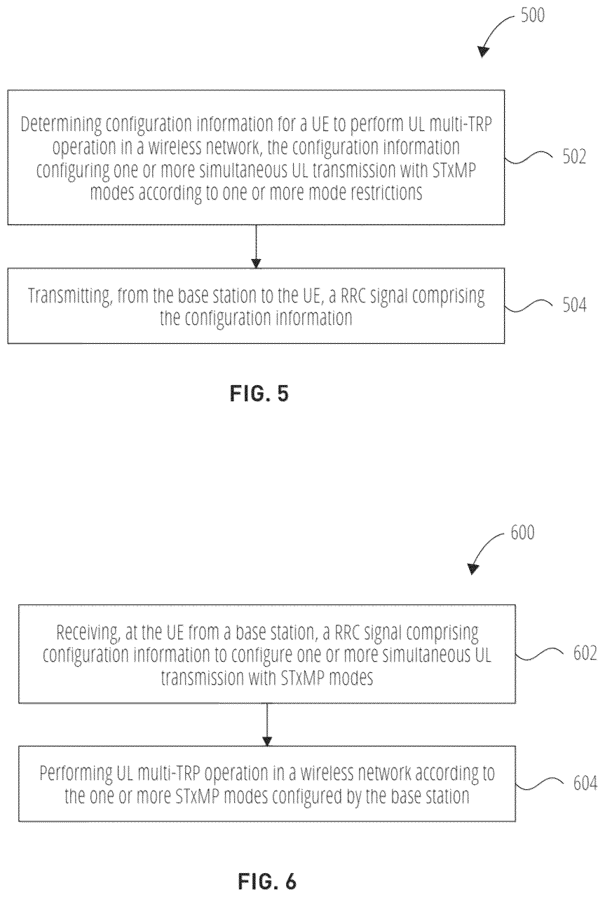

FIG. 5 illustrates a flowchart of a method 500 for a base station, according to embodiments herein. The illustrated method 500 includes determining 502 configuration information for a UE to perform UL multi-TRP operation in a wireless network, the configuration information configuring one or more simultaneous UL transmission with STxMP modes according to one or more mode restrictions. The one or more modes may be selected from a group comprising: a sDCI STxMP PUSCH SDM operation, an sDCI STxMP PUSCH SFN operation, a mDCI STxMP PUSCH operation, and an sDCI STxMP PUCCH SFN operation. The method 500 further includes transmitting 504, from the base station to the UE, an RRC signal comprising the configuration information.

In certain embodiments of the method 500, the configuration information in the RRC signal includes a PUSCH-Config information element to explicitly configure the sDCI STxMP PUSCH SDM operation, and wherein the method 500 further comprises enabling or disabling the sDCI STxMP PUSCH SDM operation per UL BWP.

In certain embodiments of the method 500, the configuration information in the RRC signal includes a BWP-UplinkDedicated information element to explicitly configure the sDCI STxMP PUSCH SDM operation, and wherein the method 500 further comprises enabling or disabling the sDCI STxMP PUSCH SDM operation per UL BWP.

In certain embodiments of the method 500, the configuration information in the RRC signal includes an UplinkConfig information element or a ServingCellConfig information element to explicitly configure the sDCI STxMP PUSCH SDM operation, and wherein the method 500 further comprises enabling or disabling the sDCI STxMP PUSCH SDM operation across UL BWPs in a same CC.

In certain embodiments of the method 500, the configuration information in the RRC signal includes a PUSCH-Config information element to explicitly configure the sDCI STxMP PUSCH SFN operation, and wherein the method 500 further comprises enabling or disabling the sDCI STxMP PUSCH SFN operation per UL BWP.

In certain embodiments of the method 500, the configuration information in the RRC signal includes a BWP-UplinkDedicated information element to explicitly configure the sDCI STxMP PUSCH SFN operation, and wherein the method 500 further comprises enabling or disabling the sDCI STxMP PUSCH SFN operation per UL BWP.

In certain embodiments of the method 500, the configuration information in the RRC signal includes an UplinkConfig information element or a ServingCellConfig information element to explicitly configure the sDCI STxMP PUSCH SFN operation, and wherein the method 500 further comprises enabling or disabling the sDCI STxMP PUSCH SFN operation across UL BWPs in a same CC.

In certain embodiments of the method 500, the one or more mode restrictions include that, in a same UL BWP in a CC, the UE is not configured with the sDCI STxMP PUSCH SDM operation and the sDCI STxMP PUSCH SFN operation simultaneously.

In certain embodiments of the method 500, the configuration information in the RRC signal includes a PUSCH-Config information element to explicitly configure the mDCI STxMP PUSCH operation, and wherein the method 500 further comprises enabling or disabling the mDCI STxMP PUSCH operation per UL BWP.

In certain embodiments of the method 500, the configuration information in the RRC signal includes a BWP-UplinkDedicated information element to explicitly configure the mDCI STxMP PUSCH operation, and wherein the method 500 further comprises enabling or disabling the mDCI STxMP PUSCH operation per UL BWP.

In certain embodiments of the method 500, the configuration information in the RRC signal includes an UplinkConfig information element or a ServingCellConfig information element to explicitly configure the mDCI STxMP PUSCH operation, and wherein the method 500 further comprises enabling or disabling the mDCI STxMP PUSCH operation across UL BWPs in a same CC.

In certain embodiments of the method 500, the configuration information in the RRC signal implicitly configures the mDCI STxMP PUSCH by configuring, in a DL BWP in a CC, two different coresetPoolIndex values for different Control ResourceSet parameters.

In certain embodiments of the method 500, the one or more mode restrictions include that, in a same UL BWP in a CC, the UE is simultaneously configured with at most one operation selected from the sDCI STxMP PUSCH SDM operation, the sDCI STxMP PUSCH SFN operation, and the mDCI STxMP PUSCH operation.

In certain embodiments of the method 500, the one or more mode restrictions include that, in a single CC, the UE is not simultaneously configured with both a first operation and a second operation on an active UL BWP and an active DL BWP, wherein the first operation comprises the sDCI STxMP PUSCH SDM operation or the sDCI STxMP PUSCH SFN operation when configured per UL BWP or UL CC, and wherein the second operation comprises the mDCI STxMP PUSCH operation when configured per DL BWP via a coresetPoolIndex information element.

In certain embodiments, the method 500 further comprises, when the UE is configured in a BWP or a CC with the sDCI STxMP PUSCH SDM operation or the sDCI STxMP PUSCH SFN operation or the mDCI STxMP PUSCH operation, configuring the UE with two SRS-ResourceSet information elements with usage of a codebook or a non-codebook. Some such embodiments further comprise, configuring the UE with PUSCH repetition indicated by: a PUSCH aggregation factor parameter in a PUSCH configuration information element, or a number of repetitions parameter in a PUSCH allocation information element. Other embodiments further comprise, rather than expecting the UE to perform the PUSCH repetition with a different beam or a different power control in different PUSCH transmissions or different repetition occasions, expecting the UE to perform the PUSCH repetition in the different PUSCH transmissions or the different repetition occasions by applying a same beam, a same precoder, or a same power control.

In certain embodiments of the method 500, the configuration information in the RRC signal includes a PUCCH-Resource information element to configure the sDCI STxMP PUCCH SFN operation, and the method further comprises at least one of: using a MAC-CE to activate two spatial relations for a PUCCH resource, and using the MAC-CE to activate two power control parameters set for the PUCCH resource. Some such embodiments further comprise configuring the UE with PUCCH repetition indicated by: a number of slots parameter in the PUCCH-Resource information element, or PUCCH repetition number of slots parameter in the PUCCH-Resource information element. Certain such embodiments further comprise, rather than expecting the UE to perform the PUCCH repetition with a different beam or a different power control in different PUCCH transmissions or different repetition occasions, expecting the UE to perform the PUCCH repetition in the different PUCCH transmissions or the different repetition occasions by applying a same beam, a same precoder, or a same power control.

In certain embodiments of the method 500, the one or more mode restrictions include that the UE is not simultaneously configured for both the sDCI STxMP PUCCH SFN operation and the mDCI STxMP PUSCH operation.

In certain embodiments of the method 500, the one or more mode restrictions include that the UE is not simultaneously configured for both the sDCI STxMP PUCCH SFN operation and the sDCI STxMP PUSCH SDM operation.

FIG. 6 illustrates a flowchart of a method 600 for a UE, according to embodiments herein. The illustrated method 600 includes receiving 602, at the UE from a base station, an RRC signal comprising configuration information to configure one or more simultaneous UL transmission with STxMP modes. The STxMP modes may be selected from a group comprising: an sDCI STxMP PUSCH SDM operation, an sDCI STxMP PUSCH SFN operation, a mDCI STxMP PUSCH operation, and an sDCI STxMP PUCCH SFN operation. The method 600 further includes performing 604 UL multi-TRP operation in a wireless network according to the one or more STxMP modes configured by the base station.

In certain embodiments of the method 600, the configuration information in the RRC signal includes a PUSCH-Config information element to explicitly configure the sDCI STxMP PUSCH SDM operation, and wherein the method 600 further comprises enabling or disabling the sDCI STxMP PUSCH SDM operation per UL BWP.

In certain embodiments of the method 600, the configuration information in the RRC signal includes a BWP-UplinkDedicated information element to explicitly configure the sDCI STxMP PUSCH SDM operation, and wherein the method 600 further comprises enabling or disabling the sDCI STxMP PUSCH SDM operation per UL BWP.

In certain embodiments of the method 600, the configuration information in the RRC signal includes an UplinkConfig information element or a ServingCellConfig information element to explicitly configure the sDCI STxMP PUSCH SDM operation, and wherein the method 600 further comprises enabling or disabling the sDCI STxMP PUSCH SDM operation across UL BWPs in a same CC.

In certain embodiments of the method 600, the configuration information in the RRC signal includes a PUSCH-Config information element to explicitly configure the sDCI STxMP PUSCH SFN operation, and wherein the method 600 further comprises enabling or disabling the sDCI STxMP PUSCH SFN operation per UL BWP.

In certain embodiments of the method 600, the configuration information in the RRC signal includes a BWP-UplinkDedicated information element to explicitly configure the sDCI STxMP PUSCH SFN operation, and wherein the method 600 further comprises enabling or disabling the sDCI STxMP PUSCH SFN operation per UL BWP.

In certain embodiments of the method 600, the configuration information in the RRC signal includes an UplinkConfig information element or a ServingCellConfig information element to explicitly configure the sDCI STxMP PUSCH SFN operation, and wherein the method 600 further comprises enabling or disabling the sDCI STxMP PUSCH SFN operation across UL BWPs in a same CC.

In certain embodiments of the method 600, in a same UL BWP in a CC, the UE does not expect to be configured with the sDCI STxMP PUSCH SDM operation and the sDCI STxMP PUSCH SFN operation simultaneously.

In certain embodiments of the method 600, the configuration information in the RRC signal includes a PUSCH-Config information element to explicitly configure the mDCI STxMP PUSCH operation, and wherein the method 600 further comprises enabling or disabling the mDCI STxMP PUSCH operation per UL BWP.

In certain embodiments of the method 600, the configuration information in the RRC signal includes a BWP-UplinkDedicated information element to explicitly configure the mDCI STxMP PUSCH operation, and wherein the method 600 further comprises enabling or disabling the mDCI STxMP PUSCH operation per UL BWP.

In certain embodiments of the method 600, the configuration information in the RRC signal includes an UplinkConfig information element or a ServingCellConfig information element to explicitly configure the mDCI STxMP PUSCH operation, and wherein the method 600 further comprises enabling or disabling the mDCI STxMP PUSCH operation across UL BWPs in a same CC.

In certain embodiments of the method 600, the configuration information in the RRC signal implicitly configures the mDCI STxMP PUSCH by configuring, in a DL BWP in a CC, two different coresetPoolIndex values for different ControlResourceSet parameters.

In certain embodiments of the method 600, in a same UL BWP in a CC, the UE does not expect to be simultaneously configured with more than one operation selected from the sDCI STxMP PUSCH SDM operation, the sDCI STxMP PUSCH SFN operation, and the mDCI STxMP PUSCH operation.

In certain embodiments of the method 600, in a single CC, the UE does not expect to be simultaneously configured with both a first operation and a second operation on an active UL BWP and an active DL BWP, wherein the first operation comprises the sDCI STxMP PUSCH SDM operation or the sDCI STxMP PUSCH SFN operation when configured per UL BWP or UL CC, and wherein the second operation comprises the mDCI STxMP PUSCH operation when configured per DL BWP via a coresetPoolIndex information element.

In certain embodiments of the method 600, when the UE is configured in a BWP or a CC with the sDCI STxMP PUSCH SDM operation or the sDCI STxMP PUSCH SFN operation or the mDCI STxMP PUSCH operation, the UE is also configured with two SRS-ResourceSet information elements with usage of a codebook or a non-codebook. In some such embodiments, the UE is also configured with PUSCH repetition indicated by: a PUSCH aggregation factor parameter in a PUSCH configuration information element, or a number of repetitions parameter in a PUSCH allocation information element. Certain such embodiments further comprise, rather than the UE performing the PUSCH repetition with a different beam or a different power control in different PUSCH transmissions or different repetition occasions, performing the PUSCH repetition in the different PUSCH transmissions or the different repetition occasions by applying a same beam, a same precoder, or a same power control.

In certain embodiments of the method 600, the configuration information in the RRC signal includes a PUCCH-Resource information element to configure the sDCI STxMP PUCCH SFN operation, the method further comprising at least one of: using a MAC-CE to activate two spatial relations for a PUCCH resource, and using the MAC-CE to activate two power control parameters set for the PUCCH resource. Some such embodiments further comprise, configuring the UE with PUCCH repetition indicated by: a number of slots parameter in the PUCCH-Resource information element, or PUCCH repetition number of slots parameter in the PUCCH-Resource information element. Certain such embodiments further comprise, rather the UE performing the PUCCH repetition with a different beam or a different power control in different PUCCH transmissions or different repetition occasions, performing the PUCCH repetition in the different PUCCH transmissions or the different repetition occasions by applying a same beam, a same precoder, or a same power control.

In certain embodiments of the method 600, the UE does not expect to be simultaneously configured for both the sDCI STxMP PUCCH SEN operation and the mDCI STxMP PUSCH operation.

In certain embodiments of the method 600, the UE does not expect to be simultaneously configured for both the sDCI STxMP PUCCH SFN operation and the sDCI STxMP PUSCH SDM operation.

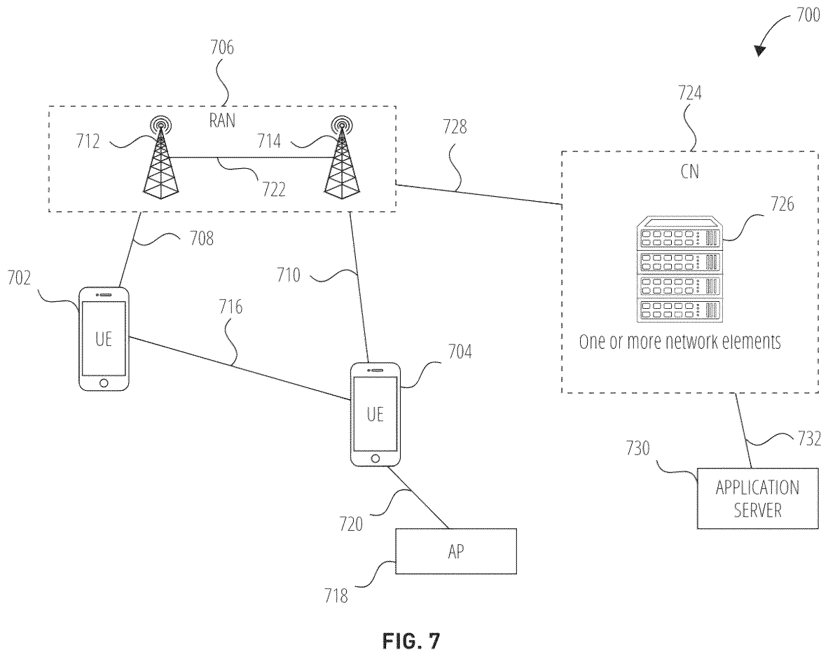

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

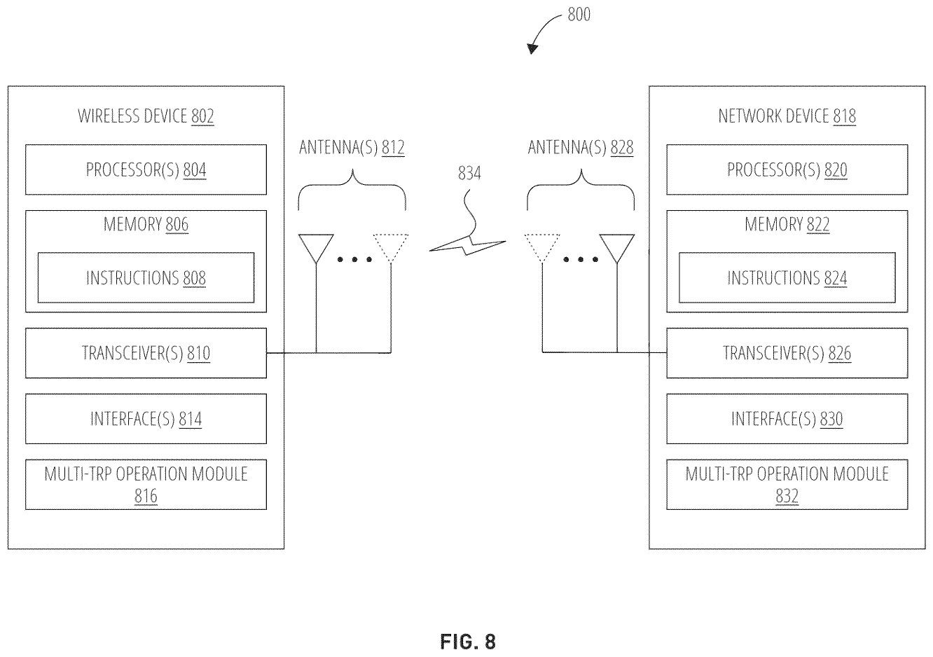

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a multi-TRP operation module 816. The multi-TRP operation module 816 may be implemented via hardware, software, or combinations thereof. For example, the multi-TRP operation module 816 may be implemented as a processor, circuit, and/or instructions 808 stored in the memory 806 and executed by the processor(s) 804. In some examples, the multi-TRP operation module 816 may be integrated within the processor(s) 804 and/or the transceiver(s) 810. For example, the multi-TRP operation module 816 may be implemented by a combination of software components (e.g., executed by a DSP or a general processor) and hardware components (e.g., logic gates and circuitry) within the processor(s) 804 or the transceiver(s) 810.

The multi-TRP operation module 816 may be used for various aspects of the present disclosure, for example, aspects of FIG. 1A, FIG. 1B, FIG. 1C, FIG. 1D, FIG. 2A, FIG. 2B, FIG. 3, and/or FIG. 6. The multi-TRP operation module 816 is configured to receive configuration information to configure a first TAT to a first TAG and a second TAT to a second TAG and determine whether a first TAG and the second TAGs are a PTAG or a STAG, respectively. Further, the multi-TRP operation module 816 is configured to perform one or more actions associated with a multi-DCI multi-TRP operation based on whether the first TAG and the second TAG are, respectively, associated with the PTAG or the STAG. In some cases, the multi-TRP operation module 816 is configured to receive an RRC signal comprising configuration information to configure one or more simultaneous UL transmission with STxMP modes selected from a group comprising: a sDCI STxMP PUSCH SDM operation, an sDCI STxMP PUSCH SFN operation, a mDCI STxMP PUSCH operation, and an sDCI STxMP PUCCH SFN operation, and perform UL multi-TRP operation in a wireless network according to the one or more STxMP modes configured by the base station.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a multi-TRP operation module 832. The multi-TRP operation module 832 may be implemented via hardware, software, or combinations thereof. For example, the multi-TRP operation module 832 may be implemented as a processor, circuit, and/or instructions 824 stored in the memory 822 and executed by the processor(s) 820. In some examples, the multi-TRP operation module 832 may be integrated within the processor(s) 820 and/or the transceiver(s) 826. For example, the multi-TRP operation module 832 may be implemented by a combination of software components (e.g., executed by a DSP or a general processor) and hardware components (e.g., logic gates and circuitry) within the processor(s) 820 or the transceiver(s) 826.

The multi-TRP operation module 832 may be used for various aspects of the present disclosure, for example, aspects of FIG. 1A, FIG. 1B, FIG. 1C, FIG. 1D, FIG. 2A, FIG. 2B, FIG. 4, and/or FIG. 5. The multi-TRP operation module 832 is configured to transmit, to a UE, configuration information to configure a first TAT corresponding to a TAG of a cell and a second TAT corresponding to a second TAG of the cell, wherein the configuration information associates at least one of the first TAG and the second TAG with a PTAG. In some cases, the multi-TRP operation module 832 is configured to determine configuration information to perform UL multi-TRP operation in a wireless network, the configuration information configuring one or more simultaneous UL transmission with STxMP modes according to one or more mode restrictions, wherein the one or more modes are selected from a group comprising: a sDCI STxMP PUSCH SDM operation, an sDCI STxMP PUSCH SFN operation, a mDCI STxMP PUSCH operation, and an sDCI STxMP PUCCH SFN operation, and transmit, an RRC signal comprising the configuration information.

Embodiments contemplated herein include an apparatus comprising means to perform one or more elements of any one or more of the method 300 and/or method 600. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of any one or more of the method 300 and/or method 600. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of any one or more of the method 300 and/or method 600. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of any one or more of the method 300 and/or method 600. This apparatus may be, for example, an apparatus of a UE (such as a wireless device 802 that is a UE, as described herein).

Embodiments contemplated herein include a signal as described in or related to one or more elements of any one or more of the method 300 and/or method 600.

Embodiments contemplated herein include a computer program or computer program product comprising instructions, wherein execution of the program by a processor is to cause the processor to carry out one or more elements of any one or more of the method 300 and/or method 600. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of any one or more of the method 400 and/or method 500. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of any one or more of the method 400 and/or method 500. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of any one or more of the method 400 and/or method 500. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of any one or more of the method 400 and/or method 500. This apparatus may be, for example, an apparatus of a base station (such as a network device 818 that is a base station, as described herein).

Embodiments contemplated herein include a signal as described in or related to one or more elements of any one or more of the method 400 and/or method 500.

Embodiments contemplated herein include a computer program or computer program product comprising instructions, wherein execution of the program by a processing element is to cause the processing element to carry out one or more elements of any one or more of the method 400 and/or method 500. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving, at the UE from a base station, configuration information to configure a first time alignment timer (TAT) corresponding to a first timing advance group (TAG) of a cell and a second TAT corresponding to a second TAG of the cell;
determining, at the UE, whether the first TAG and the second TAG are, respectively, associated with a primary timing advance group (PTAG) or a secondary timing advance group (STAG); and
when one or both of the first TAT and the second TAT expire, performing one or more actions associated with a multiple downlink control information (multi-DCI) multiple transmission reception point (multi-TRP) operation based on whether the first TAG and the second TAG are, respectively, associated with the PTAG or the STAG.

2. The method of claim 1, wherein the cell comprises a special cell (SpCell) including a primary cell (PCell) in a master cell group or a primary secondary cell (PSCell) in a secondary cell group, wherein the SpCell is configured for the multi-DCI multi-TRP operation.

3. The method of claim 2, wherein determining whether the first TAG and the second TAG are, respectively, associated with the PTAG or the STAG comprises determining that both the first TAG and the second TAG are predetermined as being associated with the PTAG.

4. The method of claim 2, wherein determining whether the first TAG and the second TAG are, respectively, associated with the PTAG or the STAG comprises determining that the first TAG is predetermined as being associated with the PTAG and the second TAG is predetermined as being associated with the STAG.

5. The method of claim 4, wherein a first TAG identifier (ID) of the first TAG is smaller than a second TAG ID of the second TAG.

6. The method of claim 2, wherein determining whether the first TAG and the second TAG are, respectively, associated with the PTAG or the STAG comprises determining that the configuration information indicates a network configuration of both the first TAG and the second TAG as being associated with the PTAG.

7. The method of claim 2, wherein determining whether the first TAG and the second TAG are, respectively, associated with the PTAG or the STAG comprises determining that the configuration information indicates a network configuration of the first TAG as being associated with the PTAG and the second TAG as being associated with the STAG.

8. The method of claim 2, wherein the one or more actions include, when the first TAG is associated with the PTAG and the second TAG is associated with the STAG, and when the first TAT expires:
considering the second TAT as expired; and
considering any running TAT of a secondary cell (SCell) as expired.

9. The method of claim 2, wherein the one or more actions include, when first TAG is associated with the PTAG and the second TAG is associated with the STAG, and when the first TAT expires:
considering that the second TAT, when running, is not expired; and
considering any running TAT of a secondary cell (SCell), other than the second TAT, as expired.

10. The method of claim 2, wherein the one or more actions include, when both the first TAG and the second TAG are associated with the PTAG, considering any running TAT, other than the first TAT and the second TAT, as expired when both the first TAT and the second TAT expire.

11. The method of claim 2, wherein the one or more actions include, when both the first TAG and the second TAG are associated with the PTAG, considering any running TAT, other than the first TAT and the second TAT, as expired when either the first TAT expires or the second TAT expires.

12. The method of claim 2, wherein the one or more actions include, when both the first TAG and the second TAG are associated with the PTAG, allowing the first TAT and the second TAT expire independently of one another.

13. The method of claim 2, wherein the one or more actions include, when both the first TAG and the second TAG are associated with the PTAG, when the first TAT expires considering the second TAT to be expired, and when the second TAT expires considering the first TAT to be expired.

14. The method of claim 2, wherein the one or more actions include, when the first TAG is associated with the PTAG and the second TAG is associated with the STAG, and when the first TAT expires, stopping downlink (DL) operation and uplink (UL) operation by the UE on both the first TAG and the second TAG.

15. The method of claim 2, wherein the one or more actions include, when both the first TAG and the second TAG are associated with the PTAG, and when both the first TAT expires and the second TAT expires, stopping downlink (DL) operation and uplink (UL) operation by the UE on both the first TAG and the second TAG.

16. The method of claim 2, wherein the one or more actions include, when both the first TAG and the second TAG are associated with the PTAG, and when at least one of the first TAT expires and the second TAT expires, stopping downlink (DL) operation and uplink (UL) operation by the UE on both the first TAG and the second TAG.

17. The method of claim 2, wherein the one or more actions include, when both the first TAG and the second TAG are associated with the PTAG, and when the first TAT expires and the second TAT is running, stopping downlink (DL) operation and uplink (UL) operation by the UE on the first TAG without impacting the DL operation and the UL operation on the second TAG.

18. The method of claim 1, wherein the cell comprises a secondary cell (SCell) configured for the multi-DCI multi-TRP operation, and wherein determining whether the first TAG and the second TAG are, respectively, associated with the PTAG or the STAG comprises considering both the first TAG and the second TAG as being associated with the STAG.

19. The method of claim 1, wherein the one or more actions include, when the first TAT expires while the second TAT is running, considering hybrid automatic repeat request (HARQ) buffers associated with both the first TAG and the second TAG to remain valid.

20. The method of claim 1, wherein the one or more actions include, when the first TAT expires while the second TAT is running, flushing hybrid automatic repeat request (HARQ) buffers associated with both the first TAG and the second TAG.

21-81. (canceled)
